(19) United States
(12) Patent Application Publication
(10) Pub. No.: US 2011/0169730 A1
(43) Pub. Date: Jul. 14, 2011

(54) SIGHT LINE INPUT USER INTERFACE UNIT, USER INTERFACE METHOD, USER INTERFACE PROGRAM, AND RECORDING MEDIUM WITH USER INTERFACE PROGRAM RECORDED

(75) Inventor: Motooki Sugihara, Sanda (JP)

(73) Assignee: Pioneer Corporation, Kanagawa-ken (JP)

(21) Appl. No.: 12/997,688

(22) PCT Filed: Jun. 13, 2008
(86) PCT No.: PCT/JP2008/060889

§ 371 Date: Mar. 10, 2011

(51) Int. Cl. G09G 5/00

(52) U.S. Cl. 345/156

(57) ABSTRACT

A sight line input user interface unit, a sight line input user interface method, a sight line input user interface program, and a recording medium with the program recorded in which the user's intention can be properly recognized to prevent a false judgment are provided. The sight line input user interface unit includes information display elements (16) for displaying information for the user on a display screen (14), a display control unit (24) for controlling the information display elements so that targets (36-1 to 36-4) to be visually identified by the user move on the display screen, sight line detecting elements (34) for detecting the sight line of the user on the display screen, and sight line judging elements (38) for judging whether or not the sight line of the user follows the moving targets on the basis of the sight line information from the sight line detecting elements.

### TECHNICAL FIELD

The present invention relates to a sight line input user interface unit, a user interface method, a user interface program, and a recording medium with the user interface program recorded, and particularly to a user interface unit for performing operations of a device by using information on a user's sight line, a user interface method, a user interface program, and a recording medium with the user interface program recorded.

### BACKGROUND ART

In the field of hands free operations, device operations using voice have been practically used. However, in such device operations using voice, there is a problem that articulate vocabularies are limited, or some interferences due to surrounding noises are present, or speech may not be made depending on a usage situation.

Thus, at present, there is proposed a technique of performing operations of a device by utilizing information on a user's sight line in a device such as HMD (head-mounted display), camera, or camera-mounted personal computer (PC). It is effective to utilize sight line information for interfaces (including device operations) with such a device in terms of utility of handsfree operations.

The sight line input device operation is likely to be an interface, since a sight line itself may work like a pointing device in widely used GUI (Graphic User Interface). Therefore, if an information display screen and a user's sight line direction are appropriately associated to each other, an effective interface may be obtained.

However, the sight line interface has the following problem to be solved.

In other words, an intention via a sight line input is not appropriately communicated to a device, and consequently, the device does not perform a desired operation, or erroneously works. This is because the sight line input is difficult to have several meanings. For example, assuming that a sight line input is used for a screen operation in GUI, it is possible to designate a specific position on the screen, and to show interest in an operation button drawn on the position, but it is not easy to communicate an intention to press or operate the button. In other words, for the GUI operation via a mouse, a cursor is positioned on the button displayed on the screen, and the button is clicked to operate the button. For a sight line input, however, it is difficult to communicate a decision corresponding to the clicking of the button.

There have been proposed the techniques described in Patent Literature 1 to Patent Literature 3 in terms of the above problem to be solved.
Patent Literature 1: Japanese Patent Application Laid-Open No. 07-283974
Patent Literature 2: Japanese Patent Application Laid-Open No. 08-030380
Patent Literature 3: Japanese Patent Application Laid-Open No. 09-018775

In a video camera provided with a sight line detecting unit of Patent Literature 1, when a user's sight line stays on an operation target displayed on a screen at a predetermined number of times or more, or for a predetermined period of time or more, it is decided that the user has an intention to select the function, and the function is executed.

In a display unit of Patent Literature 2, a sight line is used to designate a target on a screen, and a key operation via a keyboard or the like is used to decide an operation on the target.

In a sight line input unit of Patent Literature 3, a next selection operation is prohibited from being received, for a predetermined period of time immediately after a selection operation is performed through a sight line and a screen is switched, in order to prevent erroneous operations of the unit.

### DISCLOSURE OF THE INVENTION

### Problem to be Solved by the Invention

The techniques described in Patent Literature 1 to Patent Literature 3 have the following problems.

The technique of Patent Literature 1 is directed for judging a user's intention to select a target based on the staying period of time or the staying times of a sight line on the target displayed on the screen. However, according to the method for judging a user's selecting intention based on the sight line staying period of time, when the user is unintentionally gazing at one point, it may be judged that the user has an intention to select the target although the user have no particular intention, and consequently, erroneous recognition can occur. According to the method for judging a user's selecting intention based on the number of times of sight line staying, while a user's sight line is not focused on a target, the user's sight line may stay on the target incidentally at a predetermined number of times, and consequently, erroneous recognition can occur.

The technique of Patent Literature 2 is directed to communicating a user's definite intention not via a sight line but via a key operation of keyboard or the like, or manually, and the required manual input is problematic for an interface intended for handsfree operations.

The technique of Patent Literature 3 is directed to avoiding a case in which a target on the screen and a user's sight line coincide with each other incidentally for a predetermined period of time immediately after the display screen is switched. In the technique, however, an erroneous judgment can be made during a normal operation on the display screen, and thus, there is not provided an effective method for judging a user's interest or judgment on the operation target based on the sight line input.

The present invention has been made in terms of the above problems, and one example of its purpose is to provide a sight line input user interface unit capable of accurately recognizing a user's intention, and preventing erroneous judgments, a user interface method, a user interface program, and a recording medium with the user interface program recorded.

### Means for Solving the Problem

In order to solve the above problem, the invention according to claim 1 relates to a sight line input user interface unit, comprising:

information display means for displaying information for a user on a display screen;

display control means for controlling the information display means such that a target to be recognized by the user can move on the display screen of the information display means;

sight line detecting means for detecting a user's sight line on the display screen of the information display means; and

sight line judging means for judging, based on sight line information from the sight line detecting means, whether the user's sight line tracks the moving target.

In order to solve the above problem, the invention according to claim 9 relates to a sight line input user interface method, comprising:

a target moving process of moving a target to be recognized by a user on a display screen;

a sight line detecting process of detecting a user's sight line on the display screen; and

a sight line judging process of judging, based on the sight line information obtained in the sight line detecting process, whether the user's sight line tracks the moving target.

In order to solve the above problem, the invention according to claim 10 relates to a sight line input user interface program to cause a computer to function as the unit according to any one of claims 1 to 8.

In order to solve the above problem, the invention according to claim 11 relates to a recording medium in which a program according to claim 10 is readably recorded by the computer.

### BRIEF DESCRIPTION OF THE DRAWINGS

FIG. 1 is a structure diagram of a user interface unit in an HMD (head-mounted display);

FIG. 2 is a block circuit diagram of a user interface unit according to an embodiment of the present invention;

FIG. 3 is a diagram showing a state of a display screen;

FIG. 4 is a diagram showing a structure of a sight line judging section;

FIG. 5 is a diagram showing a structure of a sight line detecting section;

FIG. 6 is a diagram showing an example of a viewpoint data form;

FIG. 7 is a diagram showing an example of a judgment result form;

FIG. 8 is a flowchart diagram showing the operations of the user interface unit according to the embodiment of the present invention;

FIG. 9 is a diagram showing a state of the display screen;

FIG. 10 is a diagram showing a state of the display screen;

FIG. 11 is a diagram showing a state of the display screen;

FIG. 12 is a diagram showing a state of the display screen;

FIG. 13 is a block circuit diagram of a user interface unit according to another embodiment of the present invention;

FIG. 14 is a diagram showing a structure of a sight line judging section;

FIG. 15 is a diagram showing an information display section of a user interface unit according still another embodiment of the present invention;

FIG. 16 is a diagram showing a sight line judging section of a user interface unit according still another embodiment of the present invention;

FIG. 17 is a flowchart diagram showing the operations of the user interface unit according to still another embodiment of the present invention;

FIG. 18 is a diagram showing a state of the display screen;

FIG. 19 is a diagram showing a state of the display screen;

FIG. 20 is a diagram showing a state of the display screen;

FIG. 21 is a diagram showing a state of the display screen;

FIG. 22 is a diagram showing a state of the display screen; and

FIG. 23 is a diagram showing a state of the display screen.

### DESCRIPTION OF REFERENCE NUMERALS

14: Display screen
16: Information display section
24: Display control section
32: Sight line measuring section
34: Sight line detecting section
38: Sight line judging section
40: Track judging section
36-1 to 36-4: Target (function icon)
50: Viewpoint
56, 58, 60, 62, 64: Light emitting diode (LED)
66: Gaze judging section

### BEST MODES FOR CARRYING OUT THE INVENTION

The best modes for carrying out the present invention will be described below using the drawings.

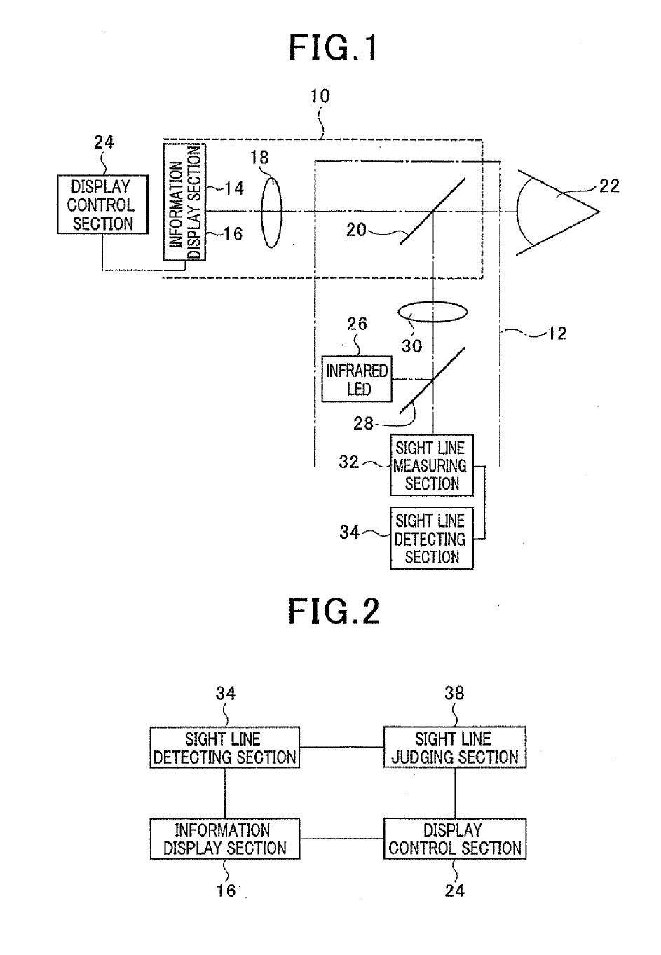

FIG. 1 shows a structure of a user interface unit in HMD (head-mounted display).

In FIG. 1, numeral 10 denotes an information display block for displaying information for a user, and numeral 12 denotes a sight line detecting block for detecting a user's sight line.

The information display block 10 includes an information display section 16 such as LCD (Liquid Crystal Display) for displaying information for the user on a display screen 14, and a light indicating the information on the display screen 14 reaches the user's eyes 22 via a convex lens 18 and a half mirror 20 as optical system. Thus, the user's eyes 22 can recognize the information on the display screen 14. A display control section 24 is connected to the information display section 16 and the display control section 24 controls the display of the information to be displayed on the display screen 14 of the information display section 16.

The sight line detecting block 12 includes an infrared LED (Light Emitting Diode) 26 and an infrared ray from the LED 26 reaches the user's eyes 22 via a half mirror 28, a convex lens 30 and the half mirror 20 as optical system. Then, a reflected light from the eyes 22 reaches a sight line measuring section 32 via the half mirror 20, the convex lens 30 and the half mirror 28 as optical system. The sight line measuring section 32 can measure an orientation of the eyes 22 or the sight line based on the reflected light from the eyes 22. A signal from the sight line measuring section 32 is output to a sight line detecting section 34.

Next, FIG. 2 shows a block circuit of a user interface unit according to an embodiment of the present invention, in which like reference numerals are denoted to like elements identical to those of FIG. 1.

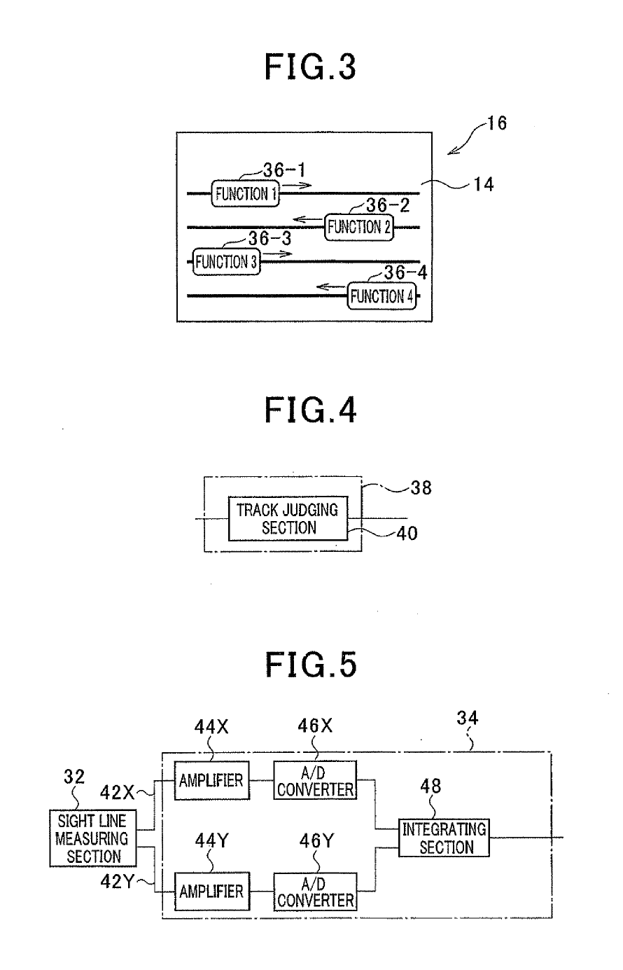

In FIG. 2, the information display section 16 is directed for displaying targets as information for the user on the display screen. With reference to FIG. 3, the display screen 14 of the information display section 16 is a function selecting screen and four targets 36-1 to 36-4 are displayed on the display screen 14. The four targets 36-1 to 36-4 indicate function 1 to function 4, respectively. The function 1 to function 4 indicated by the targets 36-1 to 36-4 are not particularly limited in their contents.

In FIG. 2, the display control section 24 controls the movements of the targets 36-1 to 36-4 on the display screen 14 of the information display section 16. In other words, with reference to FIG. 3, the two targets 36-1 and 36-3 on the display screen 14 move in the right direction of the Figure and, at the other hand, the other two targets 36-2 and 36-4 move in the left direction on the Figure under control of the display control section 24. On the display screen 14, the two targets 36-1 and 36-3 reach the end in the right direction on the Figure and in turn move in the left direction on the Figure, and similarly, the other two targets 36-2 and 36-4 reach the end in the left direction on the Figure and in turn move in the right direction.

In FIG. 2, the sight line detecting section 34 detects a sight line of the user who is looking at the display screen 14 of the information display section 16. A sight line judging section 38 judges whether the user's sight line tracks any of the targets 36-1 to 36-4 moving on the display screen 14 of the information display section 16 based on the sight line information from the sight line detecting section 34.

The characteristic points of the user interface unit according to the embodiment of the present invention will be described below.

The display control section 24 moves the targets 36-1 to 36-4 on the display screen 14 of the information display section 16 at a predetermined speed (see FIG. 3). Here, the targets 36-1 to 36-4 are to be seen by the user of the function icon or the like. The sight line judging section 30 includes a track judging section 40 as shown in FIG. 4, and the track judging section 40 judges whether the user's sight line tracks any of the targets 36-1 to 36-4, that is, whether the user's sight line smoothly tracks any of the targets based on a viewpoint data string from the sight line detecting section 34.

An eye tracking movement will be described herein. A human cannot smoothly move the eyes autonomously, that is, a human can smoothly move the eyes only when tracking a moving object or a stimulation that the human feels as if the object is moving although it is not actually moving (called apparent movement stimulation) with the eyes. The movement of the eyes observed at this time is called eye tracking movement.

The track judging section 40 according to the embodiment of the present invention is directed for recognize a user's intention from the viewpoint data string by utilizing the eye tracking movement based on the user's sight line.

The document “Measurement of 3D Eye Movements Using Image Processing” (Experimental Mechanics Vol 16, No. 3, September 2006) by Sakashita at al. describes types of the eye movements and their characteristics, and a typical measuring method.

The information display section 16, the sight line detecting section 34, the sight line judging section 38 and the display control section 24 will be described below in more detail.

The information display section 16 presents information for content viewing/listening or device operation on the display screen 14 for the user. Particularly, it displays the targets 36-1 to 36-4 to be seen during user's device operation on the display screen 14 (see FIG. 3). A user's viewpoint may be overlay-displayed on the display screen 14 based on the viewpoint data supplied from the sight line detecting section 34.

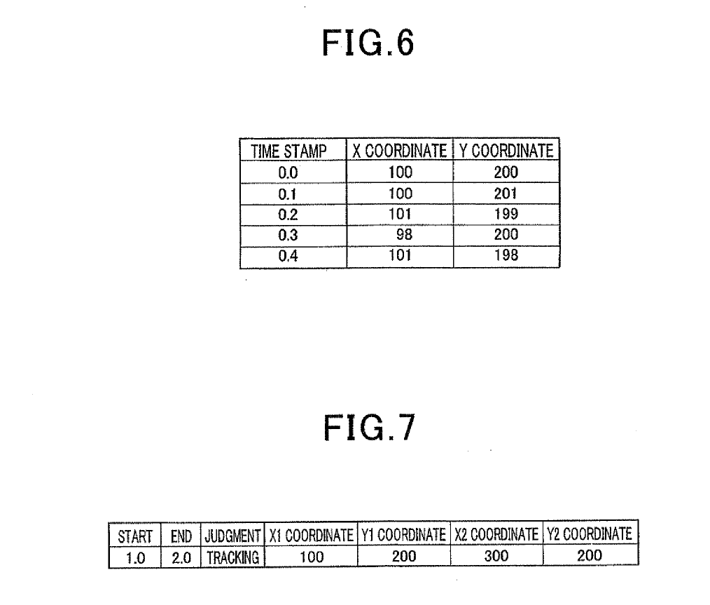

For describing the sight line detecting section 34, FIG. 5 shows a structure of the sight line detecting section 34. With reference to FIG. 5, the sight line measuring section 32 has a function of capturing an orientation of the user's eyes and an output from the sight line measuring section 32 is made of numeric signals indicating the eyes' orientation, that is, made of an X component signal 42X and a Y component signal 42Y indicating the eyes' orientation. The X component signal 42X and the Y component signal 42Y are amplified in amplifiers 44X and 44Y, respectively, so as to coincide with the viewpoint position on the display screen 14, are A/D converted by A/D converters 46X and 46Y at a proper interval of time, and then are output with a time stamp. The outputs from the A/D converters 46X and 46Y are designed to be supplied to an integrating section 48, and FIG. 6 shows an example of a form of the viewpoint data output from the integrating section 48. With reference to FIG. 6, a numeric value of the X coordinate and a numeric value of the Y coordinate both of which indicate the eyes' orientation are indicated for each time stamp.

The sight line judging section 38 includes the track judging section 40 as described above (see FIG. 4). When detecting that the user's sight line has smoothly moved from one position on the display screen 14 to the other position based on a series of viewpoint data strings supplied from the sight line detecting section 34, the track judging section 40 outputs a judgment result indicating such a state, that is, an eye tracking movement. FIG. 7 shows an example of a form of the judgment result output from the sight line judging section 38.

The display control section 24 controls the display screen 14 of the information display section 16. In other words, the display control section 24 controls the display screen 14 of the information display section 16 as described above such that the targets 36-1 to 36-4 move on the display screen 14 (see FIG. 3). The display control section 24 recognizes a user's device operation request based on the judgment result supplied from the sight line judging section 38, and changes the display screen 14 of the information display section 16 depending on the recognition.

As described above, in the user interface unit according to the embodiment of the present invention, the display control section 24 moves the targets 36-1 to 36-4 on the display screen 14 of the information display section 16 to induce the user's eye tracking movement, and the track judging section 40 in the sight line judging section 38 judges the tracking of the user's sight line for any of the moved targets 36-1 to 36-4.

In this manner, the user's eye tracking movement, which is difficult to occur incidentally, is utilized, thereby accurately recognizing the user's intention and preventing an erroneous judgment.

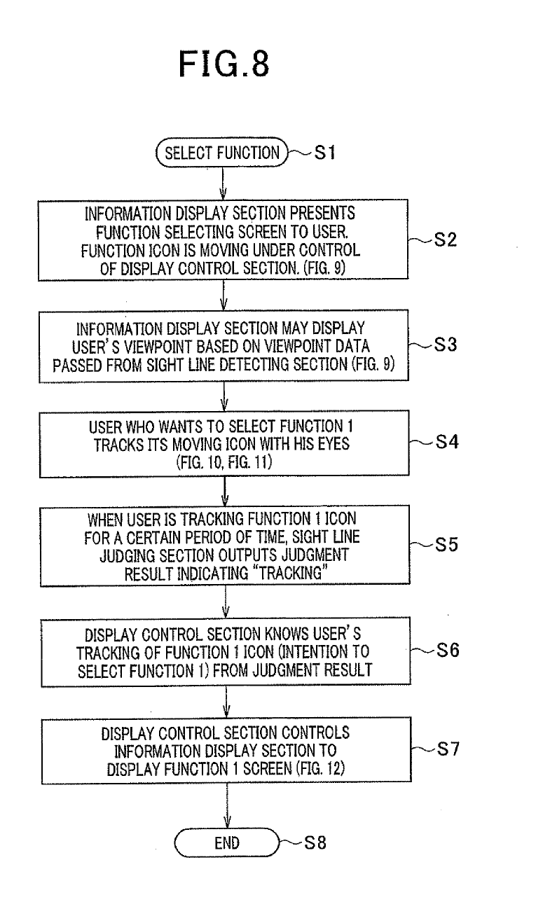

Next, the operations of the user interface unit according to the embodiment of the present invention having the above structure will be described with reference to the flowchart of FIG. 8 and the states of the display screen of FIG. 3 and FIG. 9 to FIG. 12.

In FIG. 8, a function selecting operation is started in step S1, the information display section 16 presents the function selecting screen 14 to the user in step S2, and the function icons 36-1 to 36-4 as target move under control of the display control section 24 (see FIG. 3).

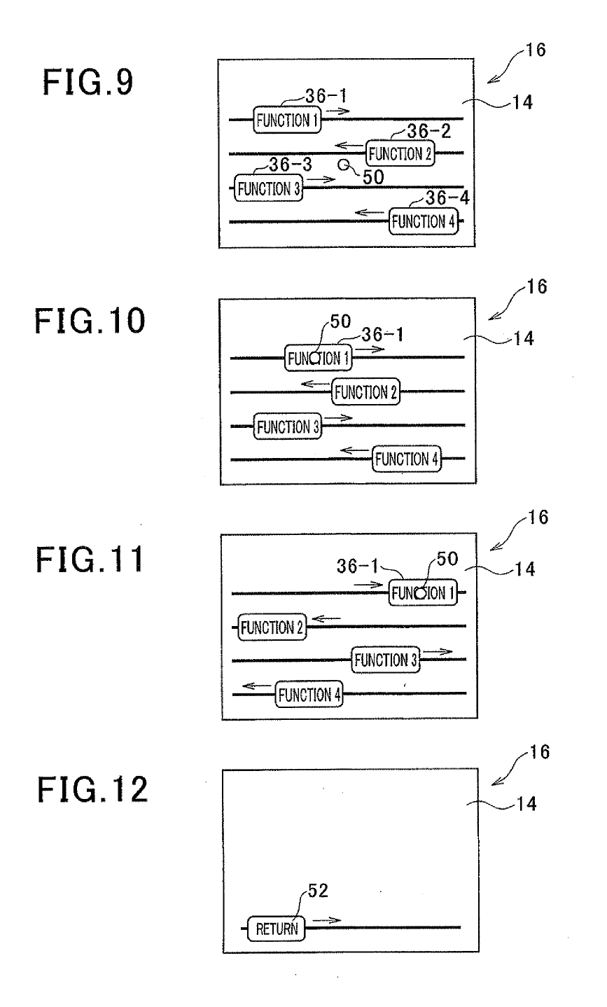

In step S3, the information display section 16 may display a user's viewpoint 50 based on the viewpoint data supplied from the sight line detecting section 34 (see FIG. 9).

In step S4, the user which wants to select the target 36-1 indicating the function 1 tracks the moving target 36-1 with the eyes (see FIG. 10 and FIG. 11).

In step S5, the target 36-1 indicating the function 1 is tracked by the user for a certain period of time, the sight line judging section 38 outputs a judgment result indicating “track.”

In step S6, the display control section 24 recognizes the user's tracking of the target 36-1 indicating the function 1 (that is, an intention to select the function 1) based on the judgment result.

In step S7, the display control section 24 controls the information display section 16 to display the display screen 14 for the function 1 (see FIG. 12), and terminates in step S8.

The display screen 14 for the function 1 is displayed in FIG. 12 and one target 52 is displayed on the display screen 14. The target 52 is a target indicating “return”, and when the user's sight line tracks the moving target 52, the function of “return” is executed. Thus, the display screen 14 for the function 1 shown in FIG. 12 returns to the previous screen, that is, the display screen 14 shown in FIG. 3 is displayed.

As described above, in the user interface unit according to the embodiment of the present invention, one or a plurality of targets (function icons and the like) on the display screen move at a predetermined speed under control of the display control section. Then, when the sight line judging section detects the eye tracking movement observed while the user was tracking any of the moving targets, it is judged that the user has selected the target at his/her definite intention, that is, it is judged that the function corresponding to the target has been selected. With the method, an accuracy of communication between the user and the device via the sight line input is remarkably improved as compared with a conventional method. This is because the communication between the user and the device is made by utilizing the eye tracking movement which is difficult to occur incidentally, that is, by utilizing the eye tracking movement which occurs with the user's definite intention.

Thus, erroneous operations of the device can be reduced and only the target's movement needs to be tracked in the simple structure, which is simple for the device operating method.

According to the embodiment of the present invention, since the display control section moves the targets on the display screen to try to induce the user's eye tracking movement, the user can track the target with the eyes to accurately select the corresponding function, and thus the device can accurately recognize the user's intention to select the function.

According to the embodiment of the present invention, when a plurality of targets are moved on the display screen, neighboring targets are controlled to move as differently as possible, for example, neighboring targets may move in different directions or a plurality of targets may be controlled to move at different speeds. In this manner, when neighboring targets move, even when the sight line detection accuracy is not so high, it is easy to judge which target the user has tracked.

According to the embodiment of the present invention, when being moved on the screen (in a direction), a target may be initially moved at a low speed. When the target is initially moved at a low speed, the user, who tries to track the target, can easily capture the movement of the target.

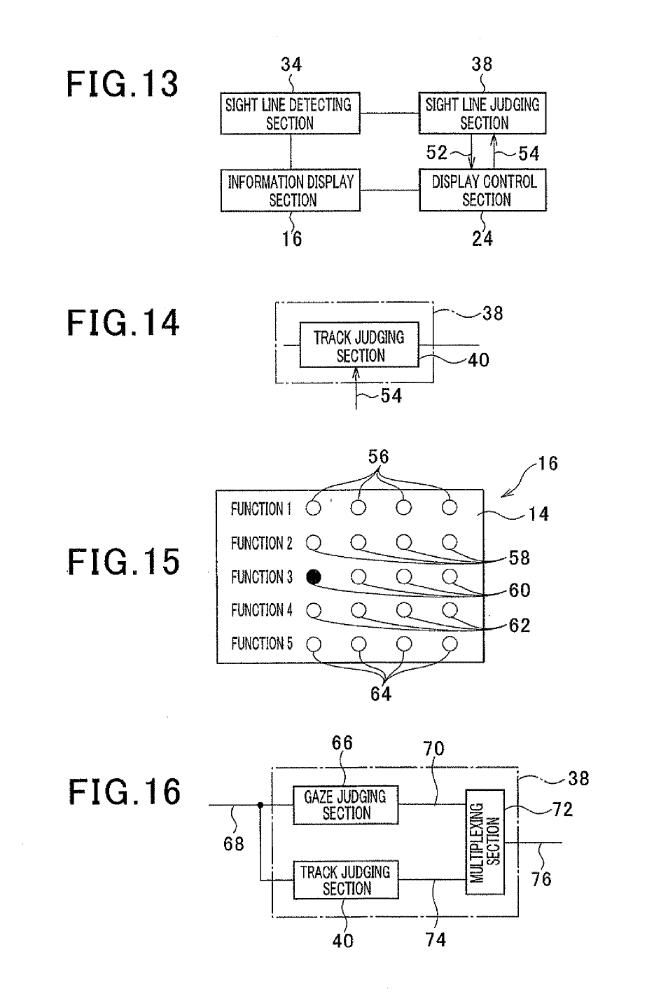

Next, FIG. 13 shows a block circuit of a user interface unit according to another embodiment of the present invention.

In FIG. 13, the sight line judging section 38 supplies the signal 52 indicating the judgment result to the display control section 24 and the display control section 24 supplies a gate signal 54 indicating “period to operate the targets” to the sight line judging section 38. The gate signal 54 is supplied to the track judging section 40 inside the sight line judging section 38 as shown in FIG. 14.

In other words, since only the period in which the display control section 24 is operating the targets is enough for the period in which the tracking judgment is made as to the user's sight line, the display control section 24 supplies the gate signal 54 indicating the “period to operate the targets” to the sight line judging section 38 and the sight line judging section 38 makes the tracking judgment as to the user's sight line only while the display control section 24 is operating the targets.

With the structure, a load on the sight line judging section 38 is alleviated. Further, it is possible to prevent the possibility that the eye tracking movement is misunderstood as the user's intentional operation due to other factor (for example, when the user tracks by change not the target movement by the display control section but another moving object).

Next, FIG. 15 shows a user interface unit according to still another embodiment of the present invention.

In FIG. 15, a plurality of light emitting diodes, which do not actually move and are fixed, are used as a means by which the information display section 16 expresses the moving targets. In other words, four light emitting diodes each (such as LED) 56, 58, 60, 62 and 64 are aligned and arranged beside the user selectable five functions (function 1 to function 5) on the display screen 14 of the information display section 16. The display control section 24 lights up the LEDs 56, 58, 60, 62 and 64 sequentially from the end (for example, sequentially from the left end to the right end), which are arranged beside the functions 1 to 5, respectively, to cause the user to track the lighting of the LEDs. For example, in FIG. 15, the LED 60 at the leftmost end among the four LEDs 60 is lit up and then the LED 60 at its immediate right is lit up, and in this manner the four LEDs 60 are sequentially lit up from the left end to the right end.

As described above, the LEDs 56, 58, 60, 62 and 64 are sequentially lit up from the end on the display screen 14 of the information display section 16 so that a stimulation (apparent movement stimulation) that one feels as if the target is moving although it is not actually moving is used to induce the eye tracking movement of the user's sight line.

With the structure in which the apparent movement stimulation is used to induce the eye tracking movement of the user's sight line, a low-cost display means (such as LED) is used to realize a highly reliable sight line input user interface unit intended by the present invention.

Next, FIG. 16 shows a user interface unit according to still another embodiment of the present invention.

In FIG. 16, the sight line judging section 38 comprises a gaze judging section 66 in addition to the track judging section 40. The gaze judging section 66 judges, based on a signal 68 of a series of viewpoint data strings, that the user's sight line concentrates on a specific area on the display screen 14, and then supplies a judgment result signal 70 indicating the fact to a multiplexing section 72. The track judging section 40 decides that the user's sight line has smoothly moved from one point to the other point on the display screen 14, and then supplies a judgment result signal 74 indicating the fact to the multiplexing section 72. When receiving any of the judgment result signal 70 or the judgment result signal 74, the multiplexing section 72 outputs a judgment result signal 76 indicating the fact to the display control section 24.

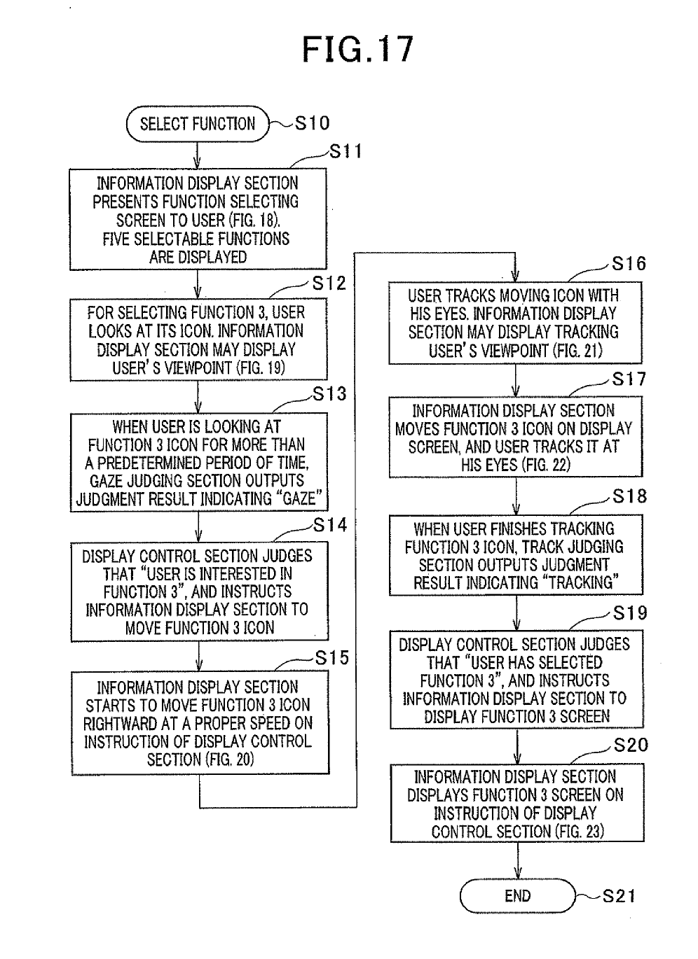

Thereby, the operations indicated in the flowchart of FIG. 17 are enabled as a whole, for example. In other words, instead of periodically moving all the targets on the display screen 14, the display control section 24 moves only the target being gazed by the user, thereby inducing the eye tracking movement for the target.

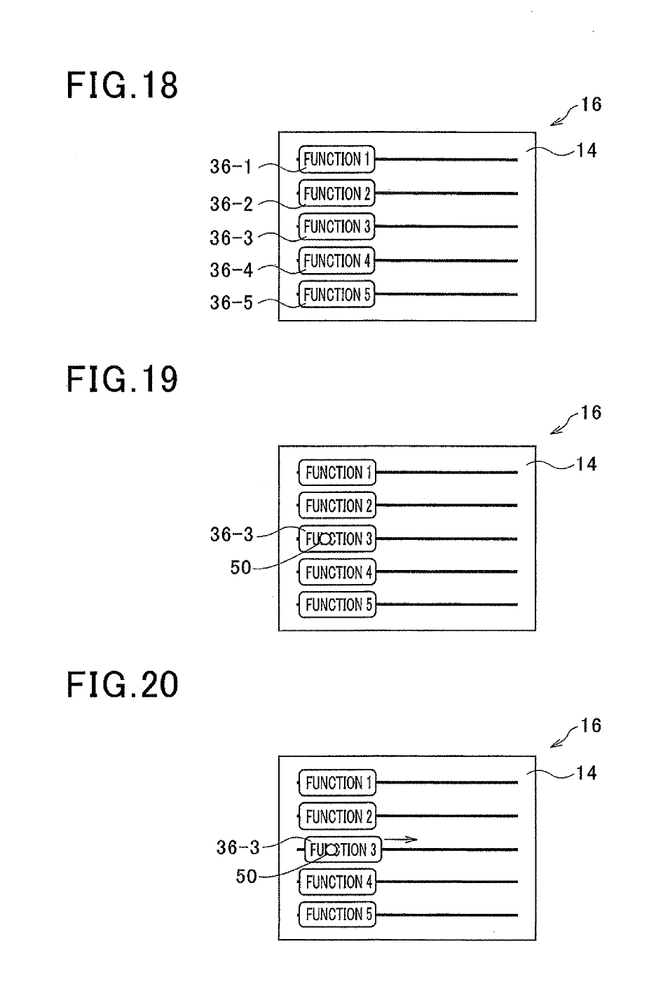

The operations indicated in the flowchart of FIG. 17 will be described below with reference to the states of the display screen shown in FIG. 18 to FIG. 23.

In FIG. 17, a function selecting operation is started in step S10, and the information display unit 16 presents the function selecting screen 14 to the user in step S11 (see FIG. 18). In FIG. 18, five selectable functions are displayed, that is, the targets 36-1 to 36-5 indicating the function 1 to the function 5, respectively, are displayed.

In step S12, the user looks at the target or icon 36-3 indicating the function 3 for selecting the function 3. The information display section 16 may display the user's viewpoint 50 for the icon 36-3 as the function 3 (see FIG. 19).

In step S13, when the user is looking at the icon 36-3 as the function 3 for more than a predetermined period of time, the gaze judging section 66 outputs the judgment result signal 70 indicating the gaze.

In step S14, the display control section 24 judges that the user is interested in the function 3, and instructs the information display section 16 to move the icon 36-3 as the function 3.

In step S15, the information display section 16 moves the icon 36-3 as the function 3 in the right direction at a proper speed in response to the instruction from the display control section 24 (see FIG. 20).

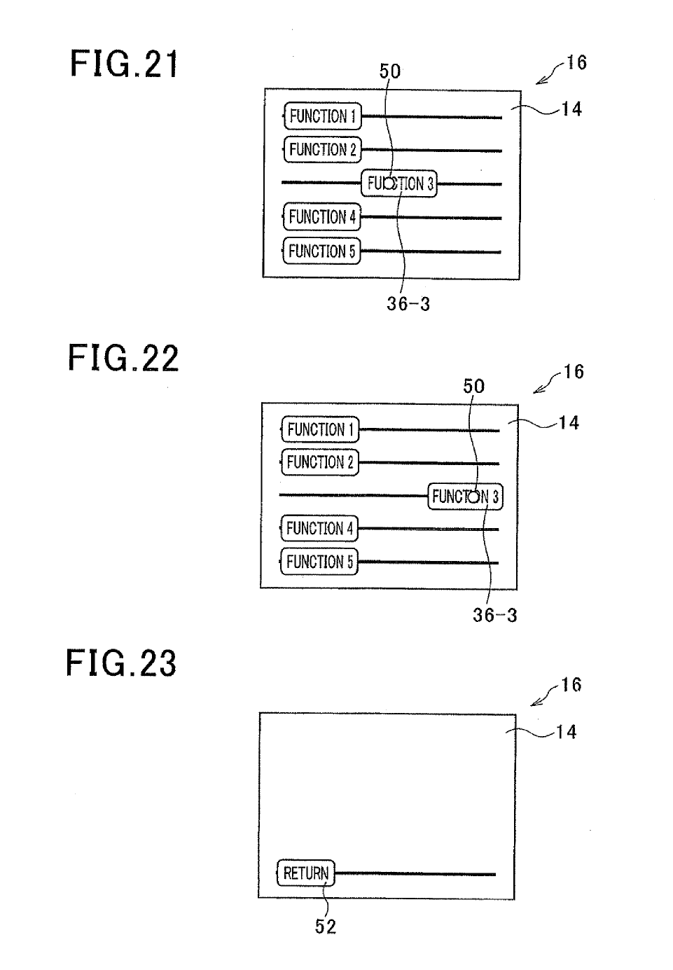

In step S16, the user tracks the moving icon 36-3 as the function 3 with the eyes. At this time, the information display section 16 may display the viewpoint 50 of the tracking user (see FIG. 21).

In step S17, the information display section 16 moves the icon 36-3 as the function 3 on the display screen 14 and tracks the icon 36-3 as the function 3 with the eyes (see FIG. 22).

In step S18, when the user terminates the tracking of the icon 36-3 as the function 3, the track judging section 40 outputs a judgment result signal indicating the tracking.

In step S19, the display control section 24 judges that the user has selected the function 3, and instructs the information display section 16 to display the display screen 14 for the function 3.

In step S20, the information display section 16 displays the display screen 14 for the function 3 in response to the instruction from the display control section 24 (see FIG. 23), and terminates in step S21.

The display screen 14 for the function 3 is displayed in FIG. 23 and one target 52 is displayed on the display screen 14. The target 52 is a target indicating “return”, and the function of “return” is executed when the user's sight line tracks the moving target 52. Thus, the display screen 14 for the function 3 shown in FIG. 23 returns to the previous screen, that is, the display screen 14 shown in FIG. 18 is displayed.

With the above structure, not only the track judging section but also the gaze judging section is provided inside the sight line judging section and the display control section moves only the target being gazed to induce the user's eye tracking movement.

Therefore, in the usage environment in which the user's viewpoint is not overlay-displayed on the display screen, the user can know a device failure such as adjustment discrepancy of the sight line detecting mechanism through an unmoving desired target being gazed.

It is further possible to avoid a situation in which a moving object is detected by the peripheral vision unpleasant to the human's eyes (looking at something outside the sight line).

When the target gazed by the user is moved, if the sight line does not track the target although the target is moved, the movement of the target may be stopped and returned to the original position. With the structure, the unwanted sight line movement operation based on the erroneous judgment due to the gaze can be reduced to the minimum, thereby enter the standby operation for waiting for a new gaze judgment.

The present invention is applicable to HMD (head-mounted display), camera/camcorder (and its user interface using a view finder), camera-mounted PC, PDA, cell phone, game player and the like.

The present invention is not limited to the above embodiments. The above embodiments are exemplary and have substantially the same structure as the technical spirit described in claims, and all the techniques having similar operation effects are encompassed in the technical range of the present invention.

1-11. (canceled)

12. A sight line input user interface unit, comprising:
an information display device which displays information for a user on a display screen;
a display control device which controls the information display device such that a target to be recognized by the user can move on the display screen of the information display device;
a sight line detecting device which detects a user's sight line on the display screen of the information display device; and
a sight line judging device which judges, based on sight line information from the sight line detecting device, whether the user's sight line tracks the moving target, to judge whether a function corresponding to the moving target is selected,
wherein the sight line judging device comprises a gaze judging device which judges, based on the sight line information from the sight line detecting device, that the user's sight line is gazing at one target, and
when the gaze judging device judges that the user's sight line is gazing at one target, the display control device controls the information display device as to move target, and the sight line judging device judges whether the user's sight line tracks the moving target.

13. The sight line input user interface unit according to claim 12,
wherein the information display device comprises a plurality of light sources aligned and arranged, and
the plurality of light sources are sequentially lit up so that the targets seem to moving on the display screen the information display device.

14. The sight line input user interface unit according to claim 12,
wherein the display control device controls the information display device such that a plurality of targets move at different directions or at different speeds on the display screen of the information display device.

15. The sight line input user interface unit according to claim 12,
wherein the display control device controls the information display device such that the targets initially move at a low speed on the display screen of the information display device.

16. The sight line input user interface unit according to claim 12,
wherein while the display control device is controlling the information display device such that the targets move on the display screen of the information display device, the sight line judging device judges whether the user's sight line is tracking the moving target.

17. The sight line input user interface unit according to claim 12,
wherein at an earlier point of time during the period during which the display control device is controlling the information display device such that the targets move on the display screen of the information display device, when the sight line judging device does not judge that the user's sight line tracks the moving target, the sight line judging device outputs a judgment result indicating the not-tracking.

18. The sight line input user interface unit according to claim 17,
wherein when the sight line judging device outputs the judgment result indicating the not-tracking, the display control device stops moving the targets on the display screen of the information display device, and returns the target to the original ion.

19. A sight line input user interface method, comprising:
a target moving process of moving a target to be recognized by a user on a display screen;
a sight line detecting process of detecting a user's sight line on the display screen; and
a sight line judging process of judging, based on the sight line information obtained in the sight line detecting process, whether the user's sight line tracks the moving target, to judge whether a function corresponding to the moving target is selected,
wherein the sight line judging process comprises a gaze judging process of judging, based on the sight line information detected in the sight line detecting process, that the user's sight line is gazing at one target, and
when the gaze judging process judges that the user's sight line is gazing at one target, the target moving process moving the target, and the sight line judging process judges whether the user's sight line tracks the moving target.

20. A recording medium in which a program is readably recorded by a computer, the program being a sight line input user interface program to cause the computer to function as the unit according to claim 12.
